(19) United States
(12) Patent Application Publication
(10) Pub. No.: US 2026/0311405 A1
(43) Pub. Date: Oct. 8, 2026

(54) INTERACTIVE 2D CANVAS SYSTEM UTILIZING SPATIAL RELATIONSHIPS FOR GENERATIVE AI CONTENT CREATION

(71) Applicant: Common Knowledge, Inc., San Francisco, CA (US)

(72) Inventor: Edward Jiao, San Francisco, CA (US)

(21) Appl. No.: 19/630,886

(22) Filed: Mar. 27, 2026

Related U.S. Application Data
(60) Provisional application No. 63/780,083, filed on Mar. 28, 2025.

(51) Int. Cl. G06T 11/60; G06F 3/04883

(52) U.S. Cl. CPC G06T 11/60; G06F 3/04883

(57) ABSTRACT

Visual interface elements are transformed into interactive user interface components within an infinite, zoomable 2D canvas system. Dynamic interaction between the user interface components and a generative artificial intelligence (AI) network enables a number of features.

### CROSS REFERENCE TO RELATED APPLICATIONS

This application claims priority to a co-pending U.S. Provisional Patent Application Ser. No. 63/780,083 filed Mar. 28, 2025, the entire contents of which are hereby incorporated by reference.

### TECHNICAL FIELD

This patent application relates to a two-dimensional canvas system that enables dynamic interaction between user interface elements and one or more generative artificial intelligence (AI) systems.

### BACKGROUND

FigJam AI — Vendor: Figma — Publication date: Nov 7, 2023

Description: Public announcement of AI features embedded in FigJam to help users generate structured boards/diagrams and automate synthesis tasks on a collaborative canvas.

This document describes canvas-resident primitives (e.g., stickies/sections as “cards/labels”) and AI-assisted creation/synthesis directly on the canvas. It also supports workflows where AI output is placed back into the board as new structured content, similar to generating content-filled “cards.” Additional (undated) help documentation describes sorting/summarizing a selection of stickies and outputting categorized copies into a new section, mapping to selection-based context extraction and new-item generation.

Copilot in Microsoft Whiteboard — Vendor: Microsoft — Publication date: Oct 2024 (blog); support pages undated

Description: Copilot features in Whiteboard support suggesting ideas, categorizing stickies, and summarizing board content, with organization keyed to what is selected or “in view.”

Copilot is described as automatically selecting all sticky notes in view, then organizing them into categories with headers, and allowing regeneration for alternate groupings—supporting spatial/viewport-scoped context derivation and AI-driven placement of structured outputs onto the canvas. The “Suggest” workflow places AI suggestions onto the whiteboard as multiple discrete sticky notes, aligning with AI-generated “cards” inserted onto the canvas.

Miro AI / AI-assisted sticky-note synthesis — Vendor: Miro — Publication date: May 24, 2023 (press release) and Mar 2023 / Aug 2024 (product updates)

Description: Miro publicly announced an AI feature suite and described AI that summarizes and creates outputs from selected stickies or board content.

The Mar 2023 update describes summarizing selected sticky notes into a single concise sticky note, mapping to selection-based contextual extraction + generated content displayed on-canvas. The Aug 2024 update describes generating ideas/diagrams/summaries based on selected items on the board or a prompt, aligning with AI that uses existing canvas objects as context and produces new canvas artifacts. An additional dated help page describes clustering stickies into containers by tags/colors/keywords, supporting automated organization of canvas items (a form of spatial regrouping).

Mural AI (mind maps, generate/actions, clustering, summarization) — Vendor: Mural — Publication dates: May 22, 2023 and Nov 1, 2023

Description: Mural disclosed and later launched AI features (mind maps, generation/actions, clustering, summarization) embedded in a visual collaboration canvas. Mural can be used for generating a mind map “in seconds” from a central idea and AI-based clustering that automatically groups sticky notes into named groups, relevant to AI generation of new canvas content from user-provided anchors and AI organization of existing “card”-like items. The Nov 2023 post characterizes clustering as a “magic wand” for organization/synthesis, relevant to a “magic selector” concept even where the exact UI differs.

Canva AI Whiteboards (Sort + summarize on an infinite canvas) — Vendor: Canva — Publication dates: Sep 5, 2023; Apr 28, 2024; Nov 6, 2024

Description: Canva disclosed Whiteboards as providing “infinite space,” then disclosed AI-powered sorting/grouping of stickies and summarization workflows for whiteboards.

Canva is described as an infinite 2D canvas plus AI that consumes existing whiteboard content (stickies/diagrams) and produces structured on-canvas outputs. The AI “Sort” feature organizes stickies by topic/themes and other attributes, supporting contextual grouping and new structured layouts derived from existing items on the canvas.

Lucid AI / AI-powered diagram generation and mind map enrichment — Vendor: Lucid Software — Publication date: Jun 4, 2024

Description: Public disclosure of AI-powered diagram generation from prompts and iterative refinement; also referenced “enrich mind maps” via Collaborative AI.

Lucid is described as generating and iterating structured visual content (diagrams) on a collaborative canvas environment from prompts and/or existing written context. It supports the general concept of prompting AI to create/expand structured nodes on a canvas, analogous to generating new “cards” that extend existing structures.

Creately VIZ — Vendor: Creately — Publication date: Nov 22, 2023

Description: Product update describing AI used within a visual collaboration platform to generate diagrams from prompts, extend shapes into flows, and organize/categorize selected elements.

Creately enables selecting a shape on the canvas and invoking VIZ to generate diagrams or “extend” shapes into flows, and to group elements by theme/sentiment/tags—relevant to selection-based AI operations, automatic generation of additional connected elements, and AI-driven restructuring of canvas items.

tldraw Agent Starter Kit — Vendor: tldraw — Publication date: Last edited Sep 16, 2024

Description: Developer-disclosed AI agent implementation that interprets and manipulates a canvas using a “visual context system” (screenshots + structured shape data) and an action system for creating/updating shapes.

The documentation for tldraw explicitly states that the agent builds context from current selection, what the user can see (viewport), a screenshot, structured shape data, and “clusters of shapes outside the viewport,” and that this provides spatial understanding and semantic meaning of shapes—directly relevant to spatial-context extraction on a 2D canvas as AI input. The action system supports creation and manipulation of multiple shapes (align/distribute/resize), relevant to automated population or rearrangement of canvas “cards.”

Excalidraw AI “Text to diagram” and related features — Vendor: Excalidraw+ — Publication date: Aug 24, 2023

Description: Changelog disclosure of AI features enabling “Text to diagram,” “Mermaid to Excalidraw,” and “Wireframe to code,” accessible within the drawing/diagram environment.

Excalidraw provides prompt-driven generation of structured diagram content on a canvas and conversion of text to structured visual objects. While not focused on proximity-based semantics, it demonstrates pre-cutoff AI-assisted generation and transformation of canvas content into structured artifacts.

### SUMMARY OF PREFERRED EMBODIMENTS

The present invention relates to an interactive, infinite, zoomable two-dimensional (2D) canvas system that enables dynamic interaction between user interface elements and one or more generative artificial intelligence (AI) systems. The system leverages spatial relationships, user input, and contextual signals to generate, transform, and organize content on the canvas.

The system comprises a set of primitives including cards, labels, selector tools, and a drawing input modality.

Labels act as human-created textual anchors that provide semantic context. Cards serve as containers for generated or user-provided content and adapt based on their size, shape, and spatial placement. Selector tools enable expansion, grouping, and transformation of existing elements. The drawing input modality enables users to provide freeform input—such as strokes, gestures, annotations, and handwritten marks—that may be interpreted as commands, selections, relationships, edits, or content creation instructions.

The system allows users to place labels anywhere on the canvas to define context. Cards may be positioned relative to labels and other cards, and may generate content either from explicit prompts or from implicit context derived from surrounding elements and spatial relationships.

Users may interact with the system through multiple input methods, including typed prompts, direct manipulation, selection tools, and drawing. Drawing input may be used to create new cards, select or group existing elements, define relationships between elements, indicate transformations, or direct an AI agent to perform one or more tasks.

In some embodiments, the system interprets drawing input in combination with spatial context to generate new content, modify existing content, or execute multi-step operations across multiple items. The system may automatically generate and position new cards, update existing cards, or create task representations based on inferred intent from drawing input and surrounding context.

### BRIEF DESCRIPTION OF THE FIGURES

FIG. 1 illustrates an example of cards disposed on a canvas.

FIG. 2 illustrates generative content using the card.

FIG. 3 shows how the system can interpret vague questions.

FIG. 4 shows how labels and cards work together to provide context-aware content.

FIG. 5 is another example of the context for cards and labels being used to generate content.

FIG. 6 is a process diagram.

FIG. 7 is a system diagram.

FIG. 8 is an example flow for an agent invoked when the user draws on the page.

FIG. 9 is an example of a drawn annotation.

### DETAILED DESCRIPTION OF PREFERRED EMBODIMENTS

### Cards

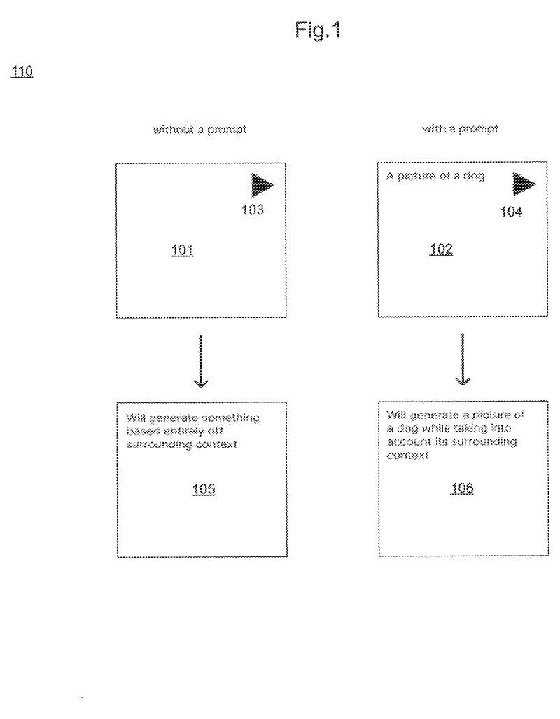

FIG. 1 illustrates examples of Cards. Cards begin in an inactive state, featuring a text field for optional user prompts. Cards 101 and 102 are two examples, the first card 101 without a prompt, and the second card 102 with a prompt. The cards 101 and 102 are instantiated on a two-dimensional interactive surface 110 such as via any convenient graphical user interface that allows a user to create, define, label and position the cards.

Without a prompt, card 101 generates content based on its spatial context. When a prompt is provided, a card such as card 102 integrates both the prompt and its surroundings to produce tailored content.

For example, by pressing the play button 103 or 104, users can activate the card, initiating the content generation process, which yields the generated outputs 105 and 106 tailord to the prompts.

The size and shape of the cards 101 and 102 may also influence the content that is generated.

### Spatial Context

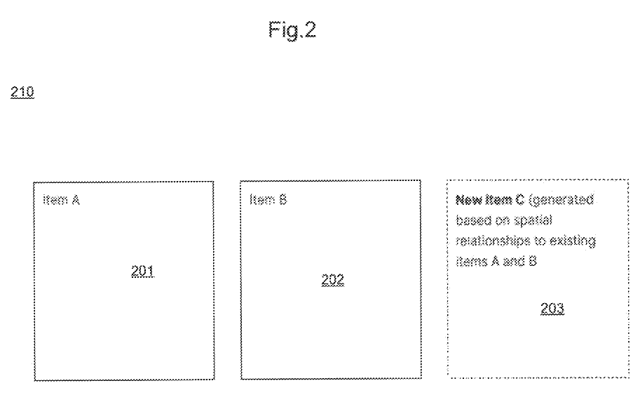

As shown in FIG. 2, Item A 201 and Item B 202 are existing elements on the infinite 2D canvas 210. New Item C 203 (shown with a dotted outline) is automatically generated by referencing the positions and content of Item A and Item B. This demonstrates how the system’s AI leverages spatial relationships to produce contextually relevant output.

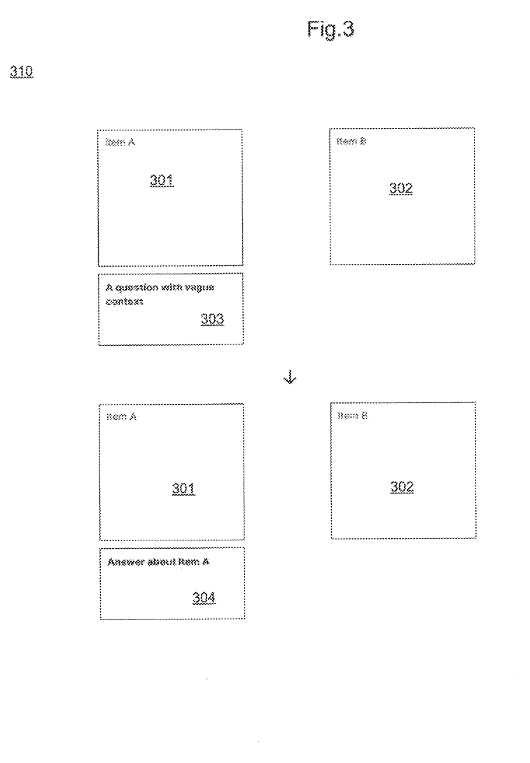

FIG. 3 demonstrates how the system interprets vague questions based on spatial proximity to relevant items. In the top row, two items—“Item A” 301 and “Item B”302 —are placed on the canvas 310, along with a “question with vague context.” 303 In the bottom row, the system then generates an “Answer about Item A,” 304 recognizing that the question is positioned near Item A. This highlights how the system leverages spatial relationships to determine which item or context the question refers to.

### Labels and Cards

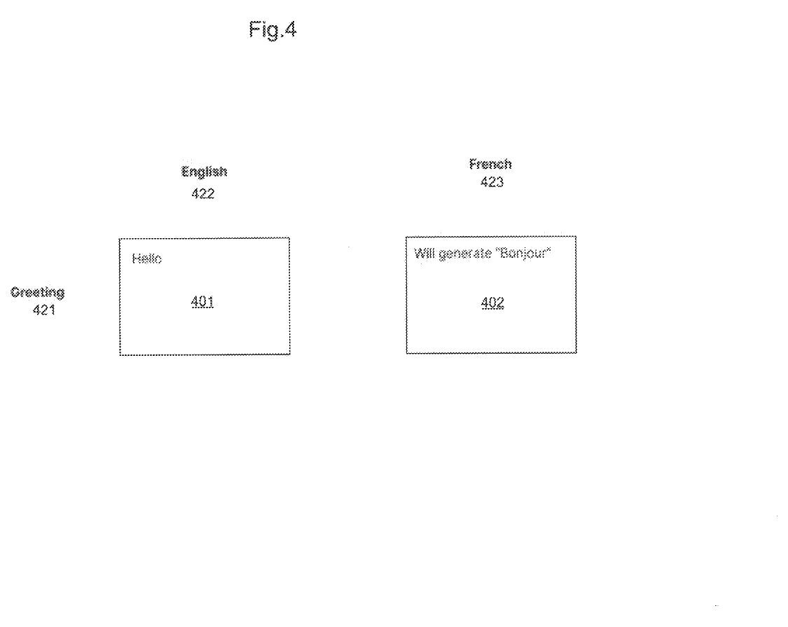

FIG. 4 is an illustration of how Labels and Cards work together to produce context-aware content. In this example, the label “Greeting” 421 for card 401 provides an overarching context, while two additional labels, “English” 422 and “French,” 423 each have a corresponding card 401 and 402. The card 401 under label “English” 422 displays the greeting “Hello,” whereas the card 402 under label “French” 423 is prompted to generate “Bonjour.” The spatial arrangement of labels informs the system that these cards should contain greetings in different languages, demonstrating how labels anchor semantic context and guide the content generated by their associated cards.

### Magic Selector

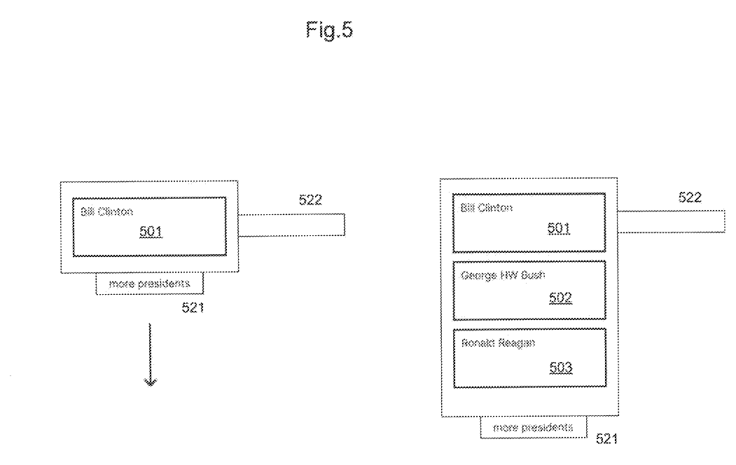

In FIG. 5 we see the Magic Selector tool in action. The tool highlights an existing card 501 (“Bill Clinton”) and presents handles (one handle 521 at the bottom and another handle 522 on the right) for expanding the selection. In this example, the user enters “more presidents” into the bottom handle’s 521 text field, then drags the selection downward (as indicated by arrow 533). The system automatically generates new cards (e.g., “George HW Bush,” 502 “Ronald Reagan” 503) to fill the expanded area vertically, using both the user’s prompt and the original card’s context. The right-side handle 522 can similarly be used for lateral expansion, allowing multi-dimensional growth of the selected content.

### Drawing Input Modality

Numerous graphical user interfaces are possible using personal computers, tables, smartphones, and other devices. In certain embodiments, the system accepts drawings generated by other tools as an input method in addition to directly entered and typed prompts, labels, direct selection, and spatial placement. Drawing input may include freehand pen strokes, touch strokes, mouse strokes, stylus marks, scribbles, arrows, paths, circles, bounding outlines, lasso shapes, cross-outs, highlights, handwritten text, pressure-sensitive marks, multi-stroke sketches, and combinations thereof.

The system may analyze one or more characteristics of the drawing input, including stroke shape, direction, order, speed, curvature, relative position, enclosure, intersection with canvas elements, endpoint locations, and temporal sequence. These characteristics may be used to infer user intent.

Drawing input may be interpreted in multiple ways, including but not limited to:

Card creation input: a drawn rectangle, enclosure, lasso, placeholder scribble, or defined region may cause the system to create a new card within or adjacent to the drawn area.

Selection input: a lasso, circle, underline, bracket, or other drawn mark may select one or more existing cards, labels, images, or files.

Relationship input: alignment in a row or column, a drawn arrow, connector line, or path between two or more items may indicate a semantic or operational relationship between them.

Edit input: a drawn stroke over or near an item may indicate that the item should be transformed, edited, removed, expanded, restyled, or otherwise modified.

Agent instruction input: one or more drawings, optionally combined with handwritten or typed text, may be interpreted as instructions directing an AI agent to perform one or more tasks with respect to selected items.

In some embodiments, drawing input is combined with spatial context from nearby labels, cards, and existing content on the canvas. Thus, the meaning of a drawing may depend on what the drawing overlaps, points to, encloses, connects, or is positioned near.

### Drawn Creation of New Cards

A user may draw a region on an empty or partially occupied area of the canvas. The system may interpret the region as a request to instantiate one or more new cards. The content of the new cards may be generated based on one or more of: the drawn geometry, nearby labels, nearby cards, textual prompts, handwritten annotations, connected arrows, and spatial context from surrounding canvas elements.

For example, a user may draw a box under a label reading “Ideas,” causing the system to generate a new card in that location containing ideas relevant to surrounding context. A user may draw multiple adjacent placeholders, causing the system to generate a corresponding plurality of cards arranged within the drawn layout.

### Drawn Commands for Editing Existing Content

A user may draw over an existing image, card, or other file representation to indicate a desired edit. For example, a user may draw an arrow toward a portion of an image and write or otherwise specify “remove,” “expand,” “change color,” “make brighter,” or another editing instruction. The system may interpret the marked location, direction, and associated text as an edit command and submit the marked item, marked region, and inferred instruction to one or more generative or non-generative models for execution.

A drawn command may specify local edits, global edits, stylistic edits, compositional edits, content addition, content removal, transformation of layout, or transformation of modality. In some embodiments, the system visually presents the drawing as an ephemeral command overlay, a persistent annotation, or a converted structured command object.

### Multi-Item and Multi-File Agent Operations

In certain embodiments, a user may draw on multiple cards, images, or file representations within the same canvas session, thereby creating a set of commands to be executed by an AI agent. Each drawing may be associated with a different item and a different requested operation. The agent may interpret the collection of drawings as a batch task specification and perform multiple edits or other actions across multiple files.

For example, a user may draw an arrow on a first image indicating “crop here,” circle a second document indicating “summarize,” and draw a connector from a third item to a new empty region indicating “make a presentation from this.” The system may interpret these marks collectively as a multi-step, multi-file agent workflow and execute such operations either sequentially or in parallel.

In some embodiments, the system generates new cards representing task plans, intermediate results, progress states, outputs, or confirmations associated with the agent’s execution of the drawn instructions.

### Gesture Semantics

Certain gestures may have predefined or learned meanings. By way of example and without limitation:

a closed loop may indicate selection of enclosed objects;

a rectangular or bounded outline may indicate creation of a new card region;

an arrow may indicate transformation direction, dependency, or target output location;

a strike-through or scribble may indicate deletion or suppression

a bracket or grouping line may indicate that multiple items should be processed together;

a sequence of arrows may indicate a workflow or ordered pipeline;

a drawn path into an empty area may indicate expansion or continuation of existing content.

These gesture meanings may be fixed, user-customizable, model-inferred, or determined from context.

### Integration with the Generative AI Network

The system may convert drawing input into structured machine-readable representations, including vector data, gesture classes, selected targets, region masks, and inferred intent descriptions. These representations, together with spatial context, textual prompts, labels, card contents, metadata, and file contents, may be submitted to a generative AI network or agentic execution system.

The generative AI network may return generated content, edited media, proposed actions, task plans, or other outputs, which may then be displayed as cards, overlays, modified files, linked outputs, or execution states on the canvas.

### System Description

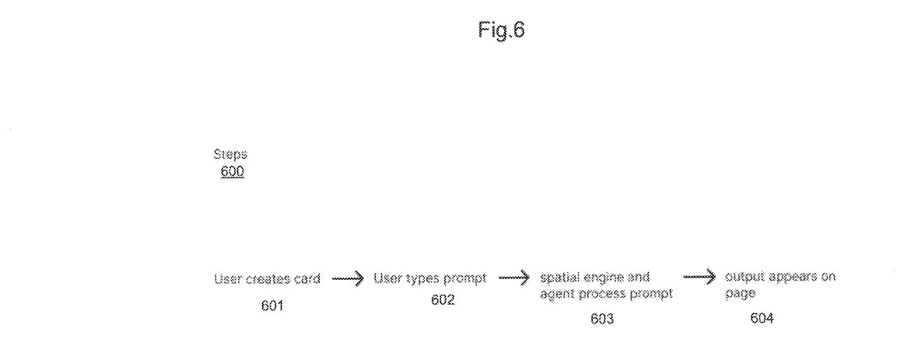

FIG. 6 shows an example flow including several steps 600 for how a user might use the invention to generate new content. In a first step 601, the user creates a card. Next in 602, the user types a prompt. In step 603, the spatial engine and agent process the card(s), their context, and the prompts. Finally, in step 604, the generative output is displayed.

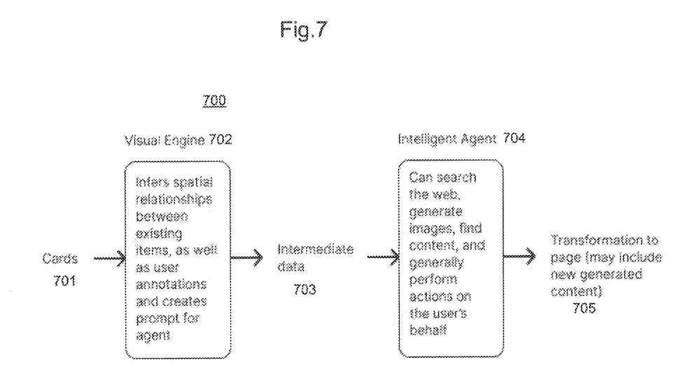

FIG. 7 diagrams an example technical architecture 700 at a high level, showing how the output is generated based on existing cards and the prompt. Cards 701 are fed to a spatial engine 702 which then infers spatial relationships between cards and displays and/or processes prompts. Intermediate data 703 produced by the spatial engine 702 is then provided to an intelligent agent 704. Agent 704 is responsible for initiating searches, and generating content such as via one or more generative artificial intelligence (GenAI) tools (e.g., ChatGPT, Microsoft Copilot, Google Gemini, and/or many other similar GenAI services), and performing other actions on the user's behalf. The agent's output 705 is then used to annotate or modify the cards or their content.

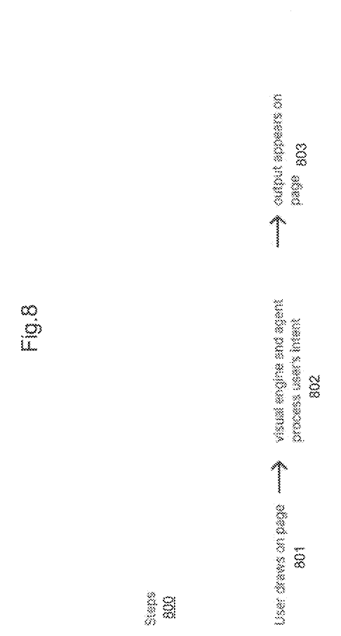

FIG. 8 is an example flow including several steps 800 for an agent invoked when the user draws on the page. In a first step 801, the user draws on a card. Next in 802, the spatial engine and agent process the user input, its context, and any other prompts or drawn annotations. Finally, in step 803, the generative output is displayed.

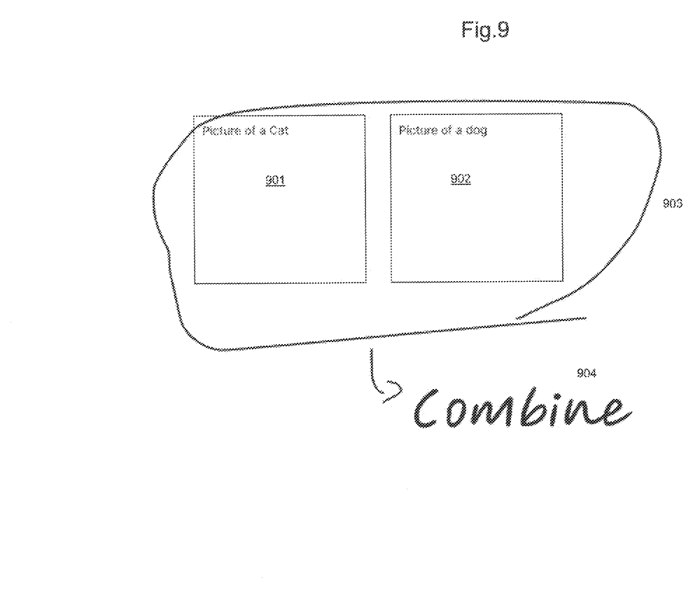

FIG. 9 is an example of a drawn annotation. Here there are two cards: one 902 with a picture of a dog, the other 901 with a picture of a cat. A hand-drawn circle 903 surrounds them, along with a hand-drawn annotation that says "combine" 904. This results in combining the two cards into a single picture of a dog and a cat together.

### Other Implementation Options

It should be understood that the example embodiments described above may be implemented in many different ways. In some instances, the various “data processors” may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system. One or more central processor units are attached to the system bus and provide for the execution of computer instructions. Also attached to the system bus are typically I/O device interfaces for connecting disks, memories, and various input and output devices. Network interface(s) allow connections to various other devices. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

The above description included an explanation of several example embodiments. It should be understood that while a particular feature may have been disclosed with respect to only one of several embodiments, that particular feature may be combined with one or more other features of the other embodiments as may be desired and advantageous for any given or particular application. It is, of course, not possible to describe every conceivable combination of components or methodologies for purposes of describing the innovations herein, and one skill in the art may now, in light of the above description, recognize that many further combinations and permutations are possible. Also, to the extent that the terms “includes,” and “including” and variants thereof are used in either the detailed description or the claims, these terms are intended to be inclusive in a manner similar to the term “comprising”.

It also should be understood that the block and flow diagrams may include more or fewer elements, be arranged differently, or be represented differently. The computing devices, processors, controllers, firmware, software, routines, or instructions as described herein may also perform only certain selected actions and/or functions. Therefore, it will be appreciated that any such descriptions that designate one or more such components as providing only certain functions are merely for convenience.

When a series of steps has been described above with respect to the flow diagrams, the order of the steps may be modified in other implementations. In addition, the operations and steps may be performed by additional or other modules or entities, which may be combined or separated to form other modules or entities. For example, while a series of steps has been described with regard to certain figures, the order of the steps may be modified in other implementations consistent with the principles explained herein. Further, non-dependent steps may be performed in parallel. Further, disclosed implementations may not be limited to any specific combination of hardware.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

Accordingly, the subject matter covered by this patent is intended to embrace all such alterations, modifications, equivalents, and variations that fall within the spirit and scope of the claims that follow.

1. A method for operating an interactive, zoomable two-dimensional (2D) canvas system integrated with a generative artificial intelligence (AI) network, the method comprising:
identifying a plurality of visual interface elements comprising cards and labels positioned on the 2D canvas;
receiving drawing input on the 2D canvas, the drawing input comprising one or more strokes, gestures, or annotations;
determining spatial context based on relationships among the visual interface elements and the drawing input;
extracting contextual information based on the spatial context;
detecting one or more prompts derived from at least one of the drawing input, user-provided input, or spatial context;
submitting the contextual information and prompts to the generative AI network;
receiving generated or modified content from the generative AI network; and
displaying the generated or modified content within one or more visual interface elements on the 2D canvas.

2. The method of claim 1, wherein the drawing input defines a region that causes creation of a new card.

3. The method of claim 1, wherein the drawing input selects one or more existing elements.

4. The method of claim 1, wherein the drawing input indicates an edit to an existing item.

5. The method of claim 1, wherein the drawing input defines relationships between elements.

6. The method of claim 1, wherein multiple drawing inputs define a plurality of tasks executed by an AI agent.

7. The method of claim 1, wherein drawing input is combined with handwritten or typed text.

8. The method of claim 1, wherein drawing input is converted into structured representations.

9. The method of claim 1, further comprising generating task representations on the canvas.

10. The method of claim 1, wherein the system distinguishes between persistent drawings and command drawings.

11. A method of directing an artificial intelligence agent within a 2D canvas system, comprising:
11a. displaying multiple items on a canvas;
11b. receiving drawing input associated with the items;
11c. interpreting the drawing input as task instructions;
11d. executing the tasks using an AI agent; and
11e. displaying outputs on the canvas.

12. A computer-implemented method for operating an interactive, zoomable two-dimensional (2D) canvas system, the method comprising:
displaying, on the 2D canvas, a plurality of visual interface elements including at least one card, at least one label, and one or more additional items;
receiving drawing input on the 2D canvas, the drawing input comprising one or more strokes, gestures, annotations, or handwritten marks;
analyzing one or more characteristics of the drawing input including at least one of stroke shape, direction, order, curvature, relative position, enclosure, intersection with a canvas element, endpoint location, or temporal sequence;
based on the analyzing, classifying the drawing input as a command type;
determining, from a spatial relationship between the drawing input and the plurality of visual interface elements, one or more target items or a target region on the 2D canvas, wherein the spatial relationship is based on whether the drawing input overlaps, points to, encloses, connects, or is positioned near the one or more target items;
converting the drawing input into a structured machine-readable representation including (i) a gesture class, (ii) an identification of the one or more target items or the target region, and (iii) an inferred intent description;
extracting contextual information associated with the one or more target items from one or more nearby labels, nearby cards, typed text, handwritten text, metadata, or file content represented on the 2D canvas;
submitting the structured machine-readable representation and the contextual information to an artificial intelligence agent or generative artificial intelligence network;
receiving, from the artificial intelligence agent or generative artificial intelligence network, output comprising at least one of generated content, modified content, a proposed action, a task plan, an intermediate result, a progress state, or an execution state; and
displaying the output on the 2D canvas as at least one new card, modified visual interface element, overlay, linked output, or task representation positioned at the target region or associated with the one or more target items.

13. The method of claim 12, wherein classifying the drawing input as the command type comprises classifying the drawing input as card creation input, and wherein the drawing input defines a bounded region that causes the system to instantiate one or more new cards within or adjacent to the bounded region.

14. The method of claim 13, wherein content for the one or more new cards is generated based on one or more of drawn geometry, nearby labels, nearby cards, textual prompts, handwritten annotations, connected arrows, or surrounding spatial context.

15. The method of claim 12, wherein classifying the drawing input as the command type comprises classifying the drawing input as edit input, and wherein the drawing input is located over or near an existing image, card, or file representation and is interpreted together with handwritten or typed text as an edit command identifying a marked item, a marked region, and an inferred editing instruction.

16. The method of claim 12, wherein classifying the drawing input as the command type comprises classifying the drawing input as relationship input, and wherein an alignment, arrow, connector line, or path between two or more items indicates a semantic or operational relationship between the two or more items or a target output location on the 2D canvas.
